(19) United States
(12) Patent Application Publication
(10) Pub. No.: US 2011/0304941 A1
(43) Pub. Date: Dec. 15, 2011

(54) SWITCHING DEVICE

(75) Inventors: Yasunari Tanimura, Kariya-shi (JP); Yusuke Shindo, Nagoya (JP)

(73) Assignee: DENSO CORPORATION, Kariya-city (JP)

(21) Appl. No.: 13/156,437

(22) Filed: Jun. 9, 2011

(30) Foreign Application Priority Data
Jun. 9, 2010 (JP) 2010-132098

(51) Int. Cl. H02H 9/02

(52) U.S. Cl. 361/93.9

(57) ABSTRACT

A switching device is provided which includes a switching element, and a current limiting circuit which limits current passing through the switching element when the current passing through the switching element exceeds a short-circuit detection threshold. The current limiting circuit limits the current passing through the switching element, until the current passing through the switching element becomes equal to or smaller than a current-limitation cancellation threshold which is smaller than the short-circuit detection threshold.

### CROSS-REFERENCE TO RELATED APPLICATION

This application is based on and claims the benefit of priority from earlier Japanese Patent Application No. 2010-132098 filed Jun. 9, 2010, the description of which is incorporated herein by reference.

### BACKGROUND

1. Technical Field

The present invention relates to a switching device including a switching element and a current limiting circuit that limits current passing through the switching element when load short occurs.

2. Related Art

Switching devices including a switching element and a current limiting circuit are well known. The current limiting circuit in such a switching device plays a role of limiting current that passes through the switching element when load short occurs. For example, JP-B-3125622 discloses a semiconductor device as such a switching device.

The semiconductor device disclosed in the above patent document includes an intelligent power module and a driver. The intelligent power module includes an IGBT (insulated gate bipolar transistor), a current detector and an overcurrent limiting circuit. The driver includes an overcurrent protective circuit and a drive circuit.

The overcurrent limiting circuit steps down gate voltage to a predetermined level when the output voltage of the current detector exceeds a predetermined operating voltage to thereby limit the current passing through the IGBT. The overcurrent protective circuit turns off the IGBT after expiration of a predetermined time when the output voltage of the current detector exceeds a predetermined operating voltage. The operating voltage of the overcurrent limiting circuit is set to a level higher than the operating voltage of the overcurrent protective circuit.

When a load connected to the IGBT is short-circuited, undue short-circuit current rapidly flows through the IGBT when the IGBT is turned on. The overcurrent limiting circuit limits the current passing through the IGBT when the output voltage of the current detector exceeds the operating voltage. The overcurrent protective circuit turns off the IGBT after expiration of a predetermined time from when the output voltage of the current detector exceeds the operating voltage. In other words, the current passing through the IGBT is limited first and then the IGBT is turned off. Thus, the IGBT is protected when load short occurs.

As mentioned above, the overcurrent limiting circuit limits the current passing through the IGBT when the output voltage of the current detector exceeds the operating voltage of the overcurrent limiting circuit. When the current passing through the IGBT is limited, the output voltage of the current detector lowers. Then, when the output voltage of the current detector becomes equal to or lower than the operating voltage of the overcurrent limiting circuit, the overcurrent limiting circuit cancels the limitation of the current passing through the IGBT. The cancellation of the limitation of the current leads to the increase of the current passing through the IGBT, which, in turn, increases the output voltage of the current detector. Then, when the output voltage of the current detector exceeds the operating voltage of the overcurrent limiting circuit, the overcurrent limiting circuit again limits the current passing through the IGBT.

In this way, the limitation and the limitation cancellation of the current passing through the IGBT may be alternately repeated until the overcurrent limiting circuit turns off the IGBT. The occurrence of such a situation will give rise to the loss in the IGBT. If the loss exceeds an energy tolerance, the IGBT will not be protected from the overcurrent but will be damaged.

### SUMMARY

An embodiment provides a switching device which is able to prevent the alternate repetition of limitation and limitation cancellation of the current passing through a switching element, and reliably protect the switching element from short-circuit in a protective operation commenced in the event of the occurrence of load short.

As an aspect of the embodiment, a switching device is provided which includes: a switching element, and a current limiting circuit which limits current passing through the switching element when the current passing through the switching element exceeds a short-circuit detection threshold, wherein the current limiting circuit limits the current passing through the switching element, until the current passing through the switching element becomes equal to or smaller than a current-limitation cancellation threshold which is smaller than the short-circuit detection threshold.

### BRIEF DESCRIPTION OF THE DRAWINGS

In the accompanying drawings:

FIG. 1 is a circuit diagram illustrating a switching device according to an embodiment of the present invention;

FIGS. 2A and 2B illustrate a collector current waveform and a gate voltage waveform of an IGBT in the switching device in the occurrence of load short;

FIG. 3 illustrates a collector current waveform of the IGBT in the occurrence of overcurrent; and

FIG. 4 is a circuit diagram illustrating an inverter device to which the embodiment is applied.

### DETAILED DESCRIPTION OF THE PREFERRED EMBODIMENTS

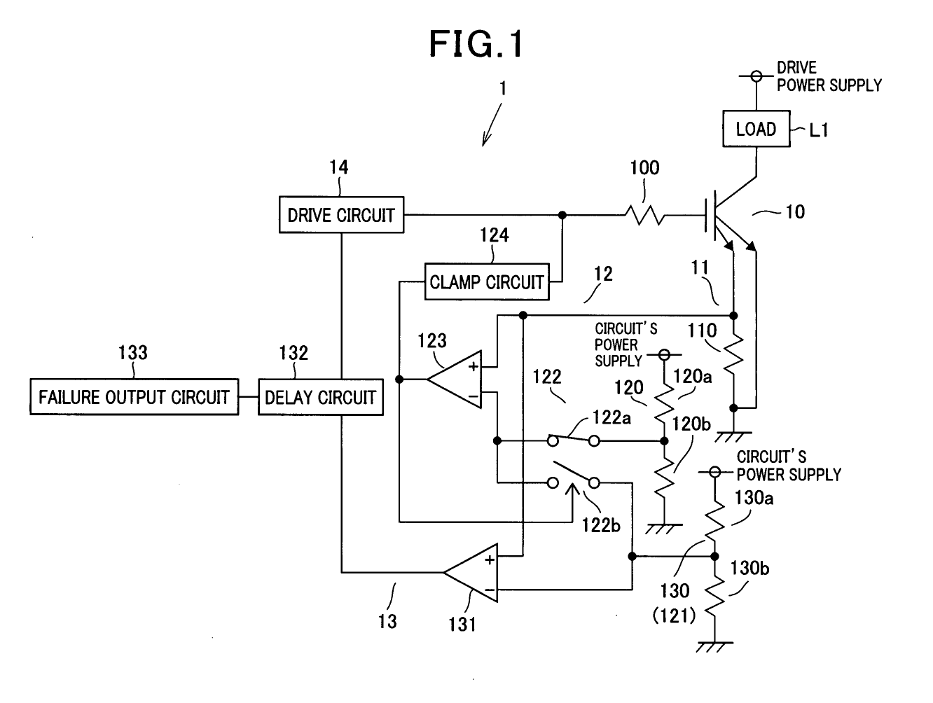

With reference to the accompanying drawings, hereinafter will be described an embodiment of the present invention. Referring to FIG. 1, first, the configuration of a switching device according to the embodiment is described. FIG. 1 is a circuit diagram illustrating the switching device according to the embodiment.

The switching device 1 shown in FIG. 1 controls the current passing through a load L1 by turning on/off a switching element based on a drive signal inputted from outside. The switching device 1 includes an IGBT (insulated gate bipolar transistor) 10 (switching element), a current detection circuit 11, a short-circuit current limiting circuit 12 (current limiting means), an overcurrent protective circuit 13 (overcurrent protecting means) and a drive circuit 14.

The IGBT 10 is an element that controls the current passing through the load L1 by being turned on/off. The IGBT 10 also serves as an element that limits the current passing through the load L1 when load short occurs. The IGBT 10 is provided with a current sensing terminal through which current is passed, the current being proportionate to and smaller than collector current. The IGBT 10 has a collector which is connected to one end of the load L1. The other end of the load L1 is connected to a drive power supply. The IGBT 10 has an emitter which is grounded and a gate which is connected to the drive circuit 14 via a gate resistor 100. The current sensing terminal is connected to the current detection circuit 11.

The current detection circuit 11 detects the collector current of the IGBT 10. Specifically, the current detection circuit 11 outputs a voltage corresponding to the collector current. The current detection circuit 11 is made up of a current sensing resistor 110. The current sensing resistor 110 has a first end which is connected to the current sensing terminal of the IGBT 10 and a second end which is grounded. The first end of the current sensing resistor 110 is also connected to the limiting circuit 12 and the overcurrent protective circuit 13.

The short-circuit current limiting circuit 12 detects load short based on the collector current of the IGBT 10 and limits the collector current of the IGBT 10 when load short occurs. The limiting circuit 12 determines the occurrence of load short when the collector current of the IGBT 10 exceeds a short-circuit detection threshold. After the collector current has exceeded the short-circuit detection threshold, the limiting circuit 12 limits the collector current to a predetermined value which is larger than a current-limitation cancellation threshold but smaller than the short-circuit detection threshold, until the collector current becomes equal to or smaller than the current-limitation cancellation threshold which is smaller than the short-circuit detection threshold. The limiting circuit 12 includes a short-circuit detection threshold generation circuit 120 (hereinafter just referred to as “short-circuit-threshold circuit 120”), a current-limitation cancellation threshold generation circuit 121 (hereinafter just referred to as “cancellation-threshold circuit 121”), a threshold switching circuit 122, a comparator 123 and a clamp circuit 124.

The short-circuit-threshold circuit 120 generates a short-circuit detection threshold. Specifically, the short-circuit-threshold circuit 120 outputs a short-circuit detection threshold in the form of voltage. The short-circuit detection threshold is used for determining the occurrence of short-circuit in the load L1 based on the collector current of the IGBT 10. The short-circuit-threshold circuit 120 is configured by serially connected resistors 120a and 120b. The resistor 120a has an end connected to a circuit's power supply and the resistor 120b has an end grounded. The connecting point between the serially connected resistors 120a and 120b is connected to the threshold switching circuit 122. The voltage of the circuit's power supply divided by the resistors 120a and 120b is outputted as the short-circuit detection threshold.

The cancellation-threshold circuit 121 generates a current-limitation cancellation threshold. Specifically, the cancellation-threshold circuit 121 outputs the current-limitation cancellation threshold in the form of voltage. After limiting the collector current of the IGBT 10 based on the collector current, the current-limitation cancellation threshold is used for determining cancellation of the current limitation. The current-limitation cancellation threshold is set to a value smaller than the short-circuit detection threshold. The cancellation-threshold circuit 121 is configured to also serve as an overcurrent detection threshold generation circuit 130 which will be described later.

For the comparator 123, the threshold switching circuit 122 switches connection between the short-circuit-threshold circuit 120 and the cancellation-threshold circuit 121 based on the output of the comparator 123. Specifically, the threshold switching circuit 122 switches the short-circuit detection threshold and the current-limitation cancellation threshold, which are comparison criteria of the comparator 123.

Up until the collector current of the IGBT 10 exceeds the short-circuit detection threshold, the threshold switching circuit 122 connects the short-circuit-threshold circuit 120 to the comparator 123. When the collector current of the IGBT 10 exceeds the short-circuit detection threshold, the threshold switching circuit 122 connects the cancellation-threshold circuit 121 to the comparator 123.

The threshold switching circuit 122 is configured by switches 122a and 122b. The switch 122a is an a-contact switch, while the switch 122b is a b-contact switch. The switch 122a has one end connected to the connecting point between the serially connected resistors 120a and 120b, and the other end connected to the comparator 123. The switch 122b has one end connected to the cancellation-threshold circuit 121 and the other end connected to the comparator 123. The switches 122a and 122b have a control terminal connected to the comparator 123.

The comparator 123 is an element that compares the output voltage of the current detection circuit 11 with the output voltage of the short-circuit-threshold circuit 120 or the output voltage of the cancellation-threshold circuit 121. Specifically, the comparator 123 compares the collector current of the IGBT 10 with the short-circuit detection threshold or the current-limitation cancellation threshold.

Up until the collector current of the IGBT 10 exceeds the short-circuit detection threshold, the comparator 123 compares the output voltage of the current detection circuit 11 with the output voltage of the short-circuit-threshold circuit 120. When the collector current of the IGBT 10 exceeds the short-circuit detection threshold, the comparator 123 compares the output voltage of the current detection circuit 11 with the output voltage of the cancellation-threshold circuit 121.

The comparator 123 has a non-inverting input terminal connected to the first end of the current sensing resistor 110. The comparator 123 has an inverting input terminal connected to an end of each of the switches 122a and 122b. The comparator 123 has an output terminal connected to the control terminal of the switches 122a and 122b and to the clamp circuit 124.

The clamp circuit 124 fixes the gate voltage (control voltage) of the IGBT 10 to a predetermined clamp voltage based on the output of the comparator 123. The clamp voltage is set to a voltage that allows the collector current of the IGBT 10 to be larger than the current-limitation cancellation threshold but smaller than the short-circuit detection threshold. The clamp circuit 124 has an input terminal connected to the output terminal of the comparator 123. The clamp circuit 124 has an output terminal connected to an end of the gate resistor 100.

The overcurrent protective circuit 13 detects overcurrent based on the collector current of the IGBT 10 and turns off the IGBT 10. The overcurrent protective circuit 13 determines the occurrence of overcurrent when the collector current of the IGBT 10 continuously exceeds an overcurrent detection threshold, which is smaller than the short-circuit detection threshold, for a predetermined time interval, and turns off the IGBT 10. The overcurrent protective circuit 13 includes the overcurrent detection threshold generation circuit 130 (hereinafter just referred to as “overcurrent-threshold circuit 130”) mentioned above, a comparator 131, a delay circuit 132 and a failure output circuit 133.

The overcurrent-threshold circuit 130 generates an overcurrent detection threshold. As mentioned above, the overcurrent-threshold circuit 130 also serves as the cancellation-threshold circuit 121 to generate the current-limitation cancellation threshold. Specifically, the overcurrent-threshold circuit 130 outputs the overcurrent detection threshold in the form of voltage. The overcurrent detection threshold is used for determining the occurrence of overcurrent based on the collector current of the IGBT 10. The overcurrent detection threshold is set to a value smaller than the short-circuit detection threshold.

The overcurrent-threshold circuit 130 is configured by serially connected resistors 130a and 130b. The resistor 130a has an end connected to a circuit's power supply, and the resistor 130b has an end grounded. The connecting point between the serially connected resistors 130a and 130b is connected to the comparator 131 and an end of the switch 122b. The voltage of the circuit's power supply divided by the resistors 130a and 130b is outputted as the overcurrent detection threshold.

The comparator 131 is an element that compares the output voltage of the current detection circuit 11 with the output voltage of the overcurrent-threshold circuit 130. Specifically, the comparator 131 compares the collector current of the IGBT 10 with the overcurrent detection threshold. The comparator 131 has a non-inverting input terminal connected to the first end of the current sensing resistor 110. The comparator 131 has an inverting input terminal connected to the connecting point between the serially connected resistors 130a and 130b. The comparator 131 has an output terminal connected to the delay circuit 132.

The delay circuit 132 determines the arising of an overcurrent state based on the output of the comparator 131. When the output of the comparator 131 is continuously at a high level for a predetermined time interval, the delay circuit 132 determines that the collector current of the IGBT 10 is in the overcurrent state. Then, the delay circuit 132 outputs a stop signal to the drive circuit 14 and an alert signal to the failure output circuit 133. The delay circuit 132 has an input terminal connected to the output terminal of the comparator 131. The delay circuit 132 has output terminals connected to the failure output circuit 133 and the drive circuit 14.

The failure output circuit 133 externally informs of the overcurrent state based on the alert signal outputted from the delay circuit 132. The failure output circuit 133 has an input terminal connected to one output terminal of the delay circuit 132.

The drive circuit 14 drives the IGBT 10 based on a drive signal from outside. The drive circuit 14 also serves as a circuit for stopping driving of the IGBT 10 based on the stop signal outputted from the delay circuit 132. The drive circuit 14 has an input terminal connected to the other output terminal of the delay circuit 132, and an output terminal connected to the gate of the IGBT 10 via the gate resistor 100.

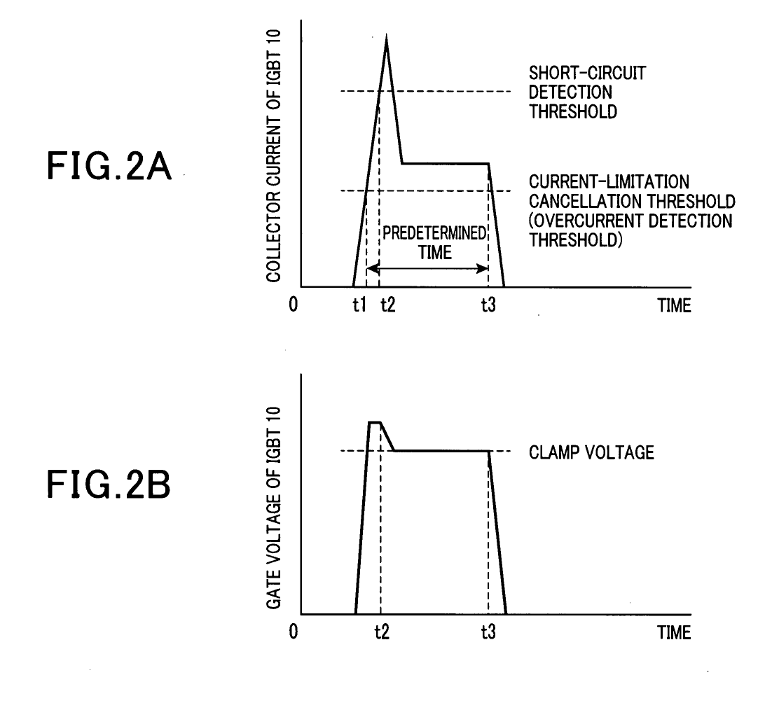

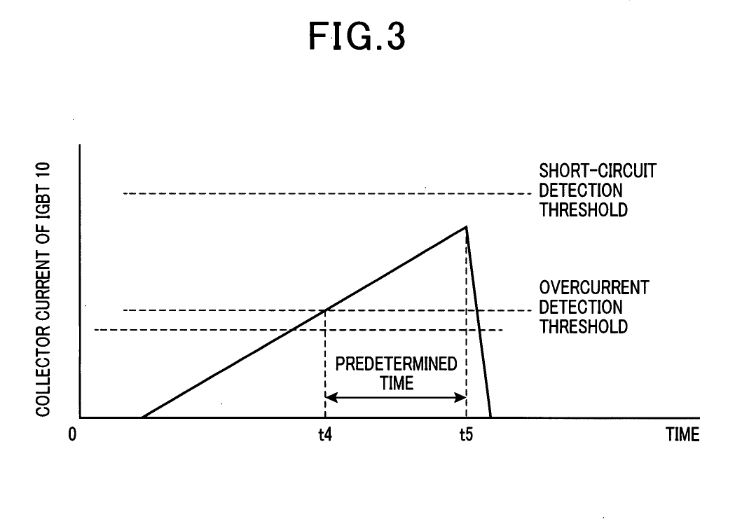

Referring now to FIGS. 1 to 3, hereinafter will be described an operation of the switching device 1. FIGS. 2A and 2B illustrate a collector current waveform and a gate voltage waveform of the IGBT 10 in the occurrence of load short. FIG. 3 illustrates a collector current waveform of the IGBT 10 in the occurrence of overcurrent.

In FIG. 1, when the load L1 connected to the collector of the IGBT 10 is short-circuited, undue short-circuit current rapidly flows through the IGBT 10 when the IGBT 10 is turned on. When the output voltage of the current detection circuit 11 exceeds the output voltage of the overcurrent-threshold circuit 130, the output of the comparator 131 at a low level turns to a high level. Specifically, as shown in FIGS. 2A and 2B, when the collector current of the IGBT 10 exceeds the overcurrent detection threshold (t1), the low-level output of the comparator 131 shown in FIG. 1 turns to a high level.

Then, when the output voltage of the current detection circuit 11 exceeds the output voltage of the short-circuit-threshold circuit 120, the output of the comparator 123 at a low level turns to a high level. Specifically, as shown in FIGS. 2A and 2B, when the collector current of the IGBT 10 exceeds the short-circuit detection threshold (t2), the low-level output of the comparator 123 shown in FIG. 1 turns to a high level.

When the output of the comparator 123 turns to a high level, the clamp circuit 124 fixes the gate voltage of the IGBT 10 to a predetermined clamp voltage. As a result, as shown in FIGS. 2A and 2B, the collector current of the IGBT 10 is limited to a predetermined value which is larger than the current-limitation cancellation threshold but smaller than the short-circuit detection threshold. Thus, the IGBT 10 is reliably protected without allowing the short-circuit detection to be cancelled.

In FIG. 1, when the output of the comparator 123 turns to a high level, the threshold switching circuit 122 disconnects the short-circuit-threshold circuit 120 from the comparator 123 and connects instead the cancellation-threshold circuit 121 to the comparator 123. Specifically, the comparison criterion of the collector current of the IGBT 10 is changed from the short-circuit detection threshold to the current-limitation cancellation threshold which is smaller than the short-circuit detection threshold. More specifically, the comparison criterion is changed to the overcurrent detection threshold.

As mentioned above, the collector current of the IGBT 10 is limited to a predetermined value which is larger than the current-limitation cancellation threshold but smaller than the short-circuit detection threshold. Moreover, the comparison criterion of the collector current of the IGBT 10 is changed to the current-limitation cancellation threshold which is smaller than the short-circuit detection threshold. Therefore, the output of the comparator 123 at a high level will not turn to a low level. Accordingly, as shown in FIGS. 2A and 2B, the collector current of the IGBT 10 is continuously limited by the clamp circuit 124. In this way, unlike the conventional art, the limitation and the limitation cancellation of the collector current will not be alternately repeated.

After that, in FIG. 1, when the high-level state of the output of the comparator 131 has continued for a predetermined time interval, the delay circuit 132 determines that the collector current of the IGBT 10 is in an overcurrent state. Then, the delay circuit 132 outputs a stop signal to the drive circuit 14 and an alert signal to the failure output circuit 133. As shown in FIGS. 2A and 2B, upon output of a stop signal by the delay circuit 132, the drive circuit 14 stops the driving of the IGBT 10 (t3). Also, upon output of an alert signal by the delay circuit 132, the failure output circuit 133 externally informs of the arising of the overcurrent state.

On the other hand, in FIG. 1, in the event that overcurrent flows through the IGBT 10 when the IGBT 10 is turned on, the collector current is increased, although the increase is not so rapid as the short-circuit current. When the output voltage of the current detection circuit 11 exceeds the output voltage of the overcurrent-threshold circuit 130, the output of the comparator 131 at a low level turns to a high level. Specifically, as shown in FIG. 3, when the collector current of the IGBT 10 exceeds the overcurrent detection threshold (t4), the low-level output of the comparator 131 shown in FIG. 1 turns to a high level.

Then, in FIG. 1, when the high-level state of the output of the comparator 131 has continued for a predetermined time interval, the delay circuit 132 determines that the collector current of the IGBT 10 is in an overcurrent state. Then, the delay circuit 132 outputs a stop signal to the drive circuit 14 and an alert signal to the failure output circuit 133. As shown in FIG. 3, upon output of a stop signal by the delay circuit 132, the drive circuit 14 stops the driving of the IGBT 10 (t5). Also, upon output of an alert signal by the delay circuit 132, the failure output circuit 133 externally informs of the arising of the overcurrent state.

Since the driving of the IGBT 10 is stopped before the collector current of the IGBT 10 exceeds the short-circuit detection threshold, the collector current will not be limited as in the occurrence of load short.

According to the present embodiment, the limitation of the collector current is not cancelled in the event that the collector current of the IGBT 10 exceeds the short-circuit detection current, followed by becoming equal to or smaller than the short-circuit detection threshold, unless the collector current becomes equal to or smaller than the current-limitation cancellation threshold which is smaller than the short-circuit detection threshold. Accordingly, the alternate repetition of limitation and limitation cancellation of the collector current is prevented from occurring. Thus, the IGBT 10 is prevented from being damaged by the collector current that would have exceeded the energy tolerance.

According to the present embodiment, the overcurrent detection threshold is also used as the current-limitation cancellation threshold. Therefore, a current-limitation cancellation threshold is not required to be separately provided, thereby simplifying the configuration.

According to the present embodiment, the collector current of the IGBT 10 is limited to a predetermined value larger than the current-limitation cancellation threshold but smaller than the short-circuit detection threshold. Accordingly, the limitation of the collector current is reliably continued without being cancelled. Thus, the IGBT 10 is prevented from being damaged by the short-circuit current.

According to the present embodiment, the gate voltage is fixed to a predetermined clamp voltage by the clamp circuit 124, in limiting the current. The clamp voltage is set such that the collector current of the IGBT 10 will be larger than the current-limitation cancellation threshold but smaller than the short-circuit detection threshold. Thus, the collector current of the IGBT 10 is reliably limited to a current larger than the current-limitation cancellation threshold but smaller than the short-circuit detection threshold.

The embodiment described above has dealt with an example of a switching device in which the current passing through the load L1 is controlled by the IGBT 10. However, the circuit configuration is not limited to the one introduced in the above embodiment.

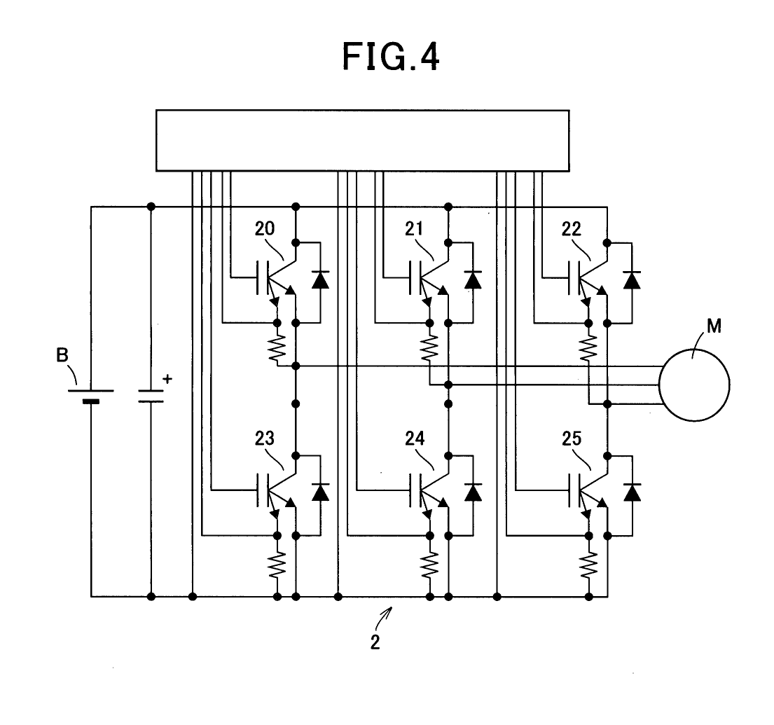

As shown in FIG. 4, the present invention may be applied to an inverter device 2 (electric power converter) which is installed in a vehicle to convert DC power of a battery B into AC power for supply to an AC motor M. The inverter device 2 includes IGBTs 20 to 24. Serial connection is established between the IGBTs 20 and 23, between the IGBTs 21 and 24, and between the IGBTs 22 and 25. The serial connections of the IGBTs 20 and 23, the IGBTs 21 and 24, and the IGBTs 22 and 25 are connected in parallel. To be more specific, the present invention may be applied to the switching circuit for the IGBTs 23 to 25. Thus, in the protective operation commenced at the occurrence of short-circuit in the IGBTs 20 to 22 (loads), the alternate repetition of limitation and limitation cancellation is prevented from occurring in the collector current passing through the IGBTs 23 to 25.

Hereinafter, aspects of the above-described embodiments will be summarized.

In order to cope with the issue set forth above, it is required that, when short-circuit is detected, the current passing through an IGBT (insulated gate bipolar transistor) is reliably retained at a fixed value so that short-circuit detection will not be cancelled.

As an aspect of the embodiment, a switching device is provided which includes: a switching element, and a current limiting circuit which limits current passing through the switching element when the current passing through the switching element exceeds a short-circuit detection threshold, wherein the current limiting circuit limits the current passing through the switching element, until the current passing through the switching element becomes equal to or smaller than a current-limitation cancellation threshold which is smaller than the short-circuit detection threshold.

With this configuration, the limitation of the current is not cancelled in the event that the current passing through the switching element exceeds the short-circuit detection current, followed by becoming equal to or smaller than the short-circuit detection threshold, unless the current becomes equal to or smaller than the current-limitation cancellation threshold which is smaller than the short-circuit detection threshold. Accordingly, the alternate repetition of limitation and limitation cancellation of the current is prevented from occurring to reliably achieve protection against short-circuit. Thus, the switching element is prevented from being damaged by the current that would have exceeded the energy tolerance.

The switching device further includes an overcurrent protecting circuit which turns off the switching element, when an overcurrent state, in which the current passing through the switching element exceeds an overcurrent detection threshold smaller than the short-circuit detection threshold, has continued for a predetermined time interval. The current-limitation cancellation threshold is the overcurrent detection threshold.

With this configuration, the overcurrent detection threshold is also used as the current-limitation cancellation threshold. Therefore, a current-limitation cancellation threshold is not required to be separately provided, thereby simplifying the configuration.

In the switching device, the current limiting circuit limits the current passing through the switching element to a predetermined value which is larger than the current-limitation cancellation threshold and smaller than the short-circuit detection threshold.

With this configuration, current limitation is reliably continued without being cancelled. Thus, the switching element is prevented from being damaged by short-circuit current.

In the switching device, the current limiting circuit fixes control voltage of the switching element to limit the current passing through the switching element.

With this configuration, the current passing through the switching element is reliably limited.

The switching device is used in an electric power converter which is installed in a vehicle and converts power.

With this configuration in which the electric power converter is installed in a vehicle, the alternate repetition of limitation and limitation cancellation of the current passing through a switching element is prevented in the protective operation commenced in the event of the occurrence of short-circuit in upper and lower arms. Thus, the switching element is prevented from being damaged by the current that would have exceeded the energy tolerance.

It will be appreciated that the present invention is not limited to the configurations described above, but any and all modifications, variations or equivalents, which may occur to those who are skilled in the art, should be considered to fall within the scope of the present invention.

What is claimed is:

1. A switching device, comprising:
a switching element, and
a current limiting circuit which limits current passing through the switching element when the current passing through the switching element exceeds a short-circuit detection threshold, wherein
the current limiting circuit limits the current passing through the switching element, until the current passing through the switching element becomes equal to or smaller than a current-limitation cancellation threshold which is smaller than the short-circuit detection threshold.

2. The switching device according to claim 1, further comprising:
an overcurrent protecting circuit which turns off the switching element, when an overcurrent state, in which the current passing through the switching element exceeds an overcurrent detection threshold smaller than the short-circuit detection threshold, has continued for a predetermined time interval, wherein
the current-limitation cancellation threshold is the overcurrent detection threshold.

3. The switching device according to claim 1, wherein
the current limiting circuit limits the current passing through the switching element to a predetermined value which is larger than the current-limitation cancellation threshold and smaller than the short-circuit detection threshold.

4. The switching device according to claim 3, wherein
the current limiting circuit fixes control voltage of the switching element to limit the current passing through the switching element.

5. The switching device according to claim 1, wherein
the switching device is used in an electric power converter which is installed in a vehicle and converts power.
